(19) United States
(12) Patent Application Publication
(10) Pub. No.: US 2005/0253549 A1
(43) Pub. Date: Nov. 17, 2005

(54) Single-phase induction motor

(75) Inventors: Byoung Wook Min, Seoul (KR); Byung Keol Choi, Inchun-si (KR); Tae Hee Lee, Buchun-si (KR)

Correspondence Address: GREENBLUM & BERNSTEIN, P.L.C., 1950 ROLAND CLARKE PLACE, RESTON, VA, 20191, US

(73) Assignee: LG Electronics Inc., Seoul (KR)

(21) Appl. No.: 11/036,016

(22) Filed: Jan. 18, 2005

(30) Foreign Application Priority Data
May 12, 2004 (KR) 2004-33593

(51) Int. Cl. H02P 7/36

(52) U.S. Cl. 318/749

(57) ABSTRACT

A single-phase induction motor comprises a main winding, an auxiliary winding, and a capacitor, and further comprises a switch for controlling current flow in the motor to change the amount of current flowing through the motor, thereby changing the effective capacitance of the capacitor. This reduces the number of capacitors used in the motor, thereby reducing manufacturing costs, and also attains a high effective capacitance using a low-capacitance capacitor.

### BACKGROUND OF THE INVENTION

1. Field of the Invention

The present invention relates to a single-phase induction motor and a method for controlling the same, and more particularly to a single-phase induction motor for controlling current flow in the motor using a switch to change the amount of current flowing through the motor, thereby changing an effective capacitance of a capacitor in the motor, and a method for controlling the same.

1. Description of the Related Art

A conventional single-phase induction motor is described below with reference to FIG. 1.

FIG. 1 is a circuit diagram of a conventional single-phase induction motor. As shown in this figure, the conventional single-phase induction motor is driven by AC power, and includes a main winding M, an auxiliary winding S, and a capacitor connected in series with the auxiliary winding S. The single-phase induction motor further includes a rotor, which is denoted by a circle between the windings M and S in FIG. 1.

The conventional single-phase induction motor configured as described above operates in the following manner.

As single-phase AC power is supplied to the motor, the main winding M produces a main alternating magnetic field. As current flows to the auxiliary winding S via the capacitor C, the auxiliary winding S produces an auxiliary alternating magnetic field that has a different phase from the main alternating magnetic field. The main and auxiliary alternating magnetic fields interact with each other to produce a rotating magnetic field, so that torque is applied to the rotor, thereby rotating the rotor.

The single-phase induction motor, which is driven by single-phase AC power, can be used in household appliances such as washing machines or dishwashers. In this case, the rotating speed of the motor must vary depending on the operating mode of the household appliance. However, since the rotating speed of the motor driven by single-phase AC power cannot be controlled, a separate drive circuit is provided in the motor, or a pole-changing single-phase induction motor is used to control the rotating speed.

Another method of controlling the rotating speed of the motor is to use a plurality of capacitors, which is described below in detail with reference to FIG. 2.

FIG. 2 is a circuit diagram of a conventional single-phase induction motor with a plurality of capacitors. As shown in this figure, the conventional single-phase induction motor includes a main winding M and an auxiliary winding S, and further includes a first capacitor C1 and a second capacitor C2. Two or more capacitors may be provided in the motor. The motor further requires a device for changing the capacitance of the capacitors, which is composed of a relay 1 or the like.

The single-phase induction motor configured as shown in FIG. 2 operates in a manner similar to the conventional motor as shown in FIG. 1. However, the single-phase induction motor of FIG. 2 has the two capacitors C1 and C2 connected in parallel with each other, and uses the relay 1 to selectively connect the second capacitor C2 to the circuit.

If the capacitance of each of the capacitors C1 and C2 is “100”, the total capacitance of the two capacitors C1 and C2 is “200” when the relay 1 is turned on so that the two capacitors C1 and C2 are connected in parallel, and the total capacitance is “100” when the relay 1 is turned off so that the second capacitor C2 is disconnected from the circuit.

If the total capacitance is increased since the two capacitors C1 and C2 are connected in parallel, the equivalent impedance of the two capacitors C1 and C2 is decreased, so that the amount of current applied to the motor is increased, and thus the motor runs with high torque. If the second capacitor C2 is disconnected from the circuit, the equivalent impedance is increased, so that the amount of current applied to the motor is decreased, and thus the motor runs with low torque.

When the single-phase induction motor starts, the relay 1 is turned on to connect the second capacitor C2 in parallel with the first capacitor C1 since it is advantageous to apply high torque to the motor when it starts due to its operating characteristics. When the single-phase induction motor runs in normal mode, the relay 1 is turned off to disconnect the second capacitor C2 from the circuit, so that low torque is applied to the motor to increase the operational efficiency of the motor.

However, if the single-phase induction motor uses a plurality of capacitors to control the speed of the motor and the amount of torque applied to the motor, the use of the plurality of capacitors increases manufacturing costs of the motor. The motor also requires a capacitance-changing device that controls connection of the plurality of capacitors, thereby incurring additional costs.

### SUMMARY OF THE INVENTION

Therefore, the present invention has been made in view of the above problems, and it is an object of the present invention to provide a single-phase induction motor for controlling current flow in the motor using a switch to change the amount of current flowing through the motor, thereby changing the effective capacitance of a capacitor in the motor, and thus making it possible to control the speed of the motor and the amount of torque applied to the motor without need for a plurality of capacitors.

In accordance with one aspect of the present invention, the above and other objects can be accomplished by the provision of a single-phase induction motor comprising a main winding, an auxiliary winding, and a capacitor, the motor further comprising a switch for controlling current flow in the motor to change the amount of current flowing through the motor, thereby changing an effective capacitance of the capacitor.

Preferably, the switch is connected in parallel with the capacitor, and the switch is a triac.

Current flow in the motor is controlled according to the ON/OFF states of the switch, and the amount of current flowing through the motor can be changed by controlling the ON duration of the switch.

The ON duration of the switch is controlled by turning on the switch for a predetermined time in phase with the frequency of AC voltage applied to the motor.

In one embodiment, the single-phase induction motor is used for a washing machine. In another embodiment, the single-phase induction motor is used for a dishwasher. The ON duration of the switch is controlled according to the operating mode of the motor, the washing machine or the dishwasher, so that the washing machine can perform each of the washing and drying cycles in multiple steps with different speeds (i.e., low and high speeds) and the dishwasher can also perform the washing cycle in multiple steps with different speeds (i.e., low and high speeds).

In accordance with another aspect of the present invention, there is provided a method for controlling a single-phase induction motor used for a washing machine, the motor including a switch for controlling current flow in the motor to change the amount of current flowing through the motor, the method comprising decreasing ON duration of the switch to rotate the motor at low speed when the washing machine operates in a wash cycle; and increasing the ON duration of the switch to rotate the motor at high speed when the washing machine operates in a dry cycle.

Preferably, the method further comprises increasing the ON duration of the switch to rotate the motor at high speed when the washing machine operates in the wash cycle, so that the washing machine performs the wash cycle in multiple steps with different rotating speeds of the motor.

Preferably, the method further comprises decreasing the ON duration of the switch to rotate the motor at low speed when the washing machine operates in the dry cycle, so that the washing machine performs the dry cycle in multiple steps with different rotating speeds of the motor.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a circuit diagram of a conventional single-phase induction motor;

FIG. 2 is a circuit diagram of a conventional single-phase induction motor with a plurality of capacitors;

FIG. 3 is a circuit diagram of a single-phase induction motor according to the present invention, which employs a switch to control current flow in the motor;

FIG. 4 is a circuit diagram of a single-phase induction motor according to the present invention, in which a triac is used as the switch in FIG. 3;

FIG. 5 is a graph illustrating how the switch operates in phase with the frequency of AC voltage;

FIG. 6 is a graph illustrating the effective capacitance of a capacitor in the motor according to the operating state of the switch; and

FIG. 7 is a flow chart of a method for controlling a single-phase induction motor used for a washing machine, according to the present invention.

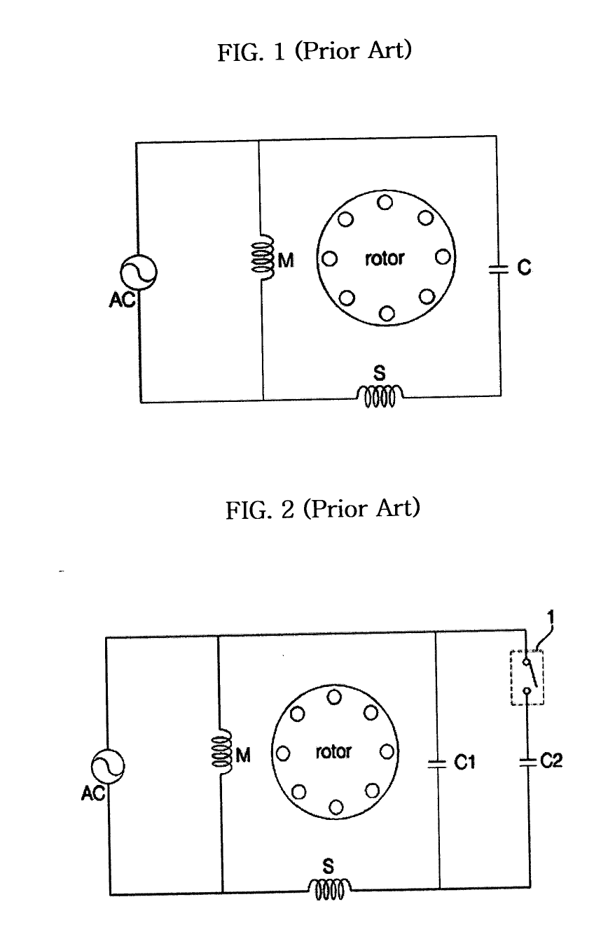

### DESCRIPTION OF THE PREFERRED EMBODIMENTS

Embodiments of a single-phase induction motor according to the present invention will now be described in detail with reference to the accompanying drawings. The same or similar elements are referred to by the same terms in the description of the embodiments and they are also denoted by the same reference numerals in the drawings.

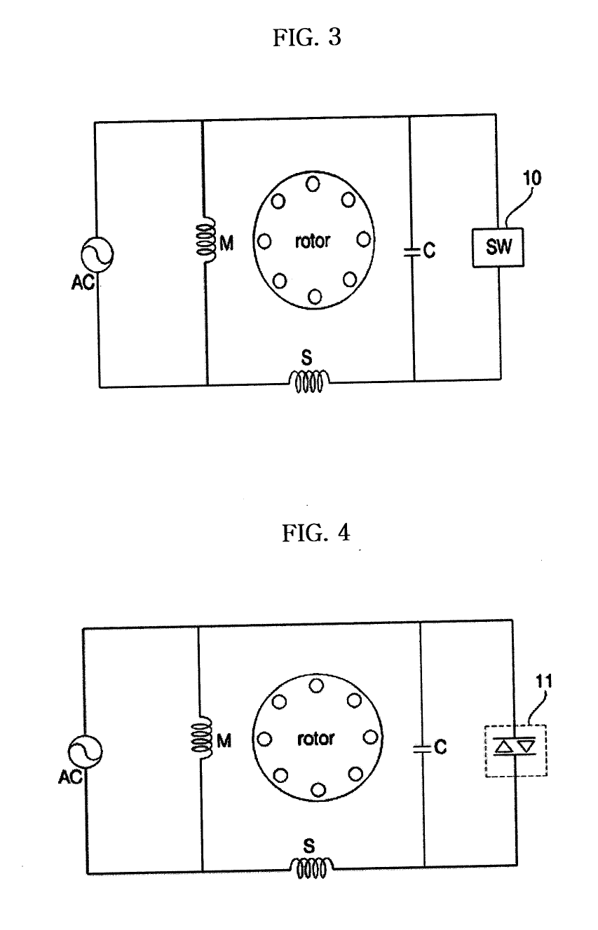

FIG. 3 is a circuit diagram of a single-phase induction motor according to the present invention, which employs a switch to control current flow in the motor. FIG. 4 is a circuit diagram of a single-phase induction motor according to the present invention, in which a triac is used as the switch in FIG. 3.

As shown in FIGS. 3 and 4, the single-phase induction motor according to the present invention includes a rotor, a main winding M, an auxiliary winding S, and a capacitor C. The capacitor C is connected in series with the auxiliary winding S so that the phase of current flowing through the auxiliary winding S has a predetermined difference with the phase of current flowing through the main winding M.

In particular, the single-phase induction motor according to the present invention further includes a switch 10 connected in parallel with the capacitor C. The switch 10 is used to change the amount of current flowing in the motor, thereby changing the effective capacitance of the capacitor C.

As shown in FIG. 4, a triac 11 can be used as the switch 10. A switching element, such as a relay for controlling supply of AC power, can also be used as the switch 10.

The operation of the single-phase induction motor according to the present invention will now be described in detail with reference to FIGS. 3 and 4.

As an AC drive voltage is applied to the motor, the main winding M produces a main alternating magnetic field. As a current, which has a different phase from the current flowing to the main winding M, flows to the auxiliary winding S, the auxiliary winding S produces an auxiliary alternating magnetic field whose phase is different from the main alternating magnetic field produced by the main winding M, so that a rotating torque is applied to the rotor.

The rotating torque varies depending on the amount of current applied to the auxiliary winding S. When a large amount of current is applied to the auxiliary winding S, the motor runs at high speed with high torque. When a small amount of current is applied to the auxiliary winding S, the motor runs at low speed with low torque.

By turning on/off the switch 10 connected in parallel with the capacitor C, it is possible to control current flow to the auxiliary winding S, thereby changing the amount of current flowing through the motor. This is possible because the equivalent impedance of a combination of the switch 10 and the capacitor C is reduced when the switch 10 is turned on, and the equivalent impedance is increased when the switch 10 is turned off.

That is, if the switch 10 is turned on, the amount of current applied to the auxiliary winding S is increased due to the reduced equivalent impedance. If the switch 10 is turned off, the amount of current applied to the auxiliary winding S is reduced due to the increased equivalent impedance.

When AC voltage is applied to the capacitor C, the impedance of the capacitor C is inversely proportional to the capacitance of the capacitor C. Therefore, turning the switch 10 on has the same effect as when increasing the effective capacitance of the capacitor C. Turning the switch 10 off has the same effect as when reducing the effective capacitance of the capacitor C.

As shown in FIG. 4, the triac 11 can be used as the switch 10. The triac 11 is a type of semiconductor switch that controls the passage of AC current and adjusts its average current. A controller (not shown) for transferring a control signal to the switch 10 is also provided. The controller transfers a suitable control signal to the switch 10 according to the operating state of a device including the motor, so as to turn on/off the switch 10.

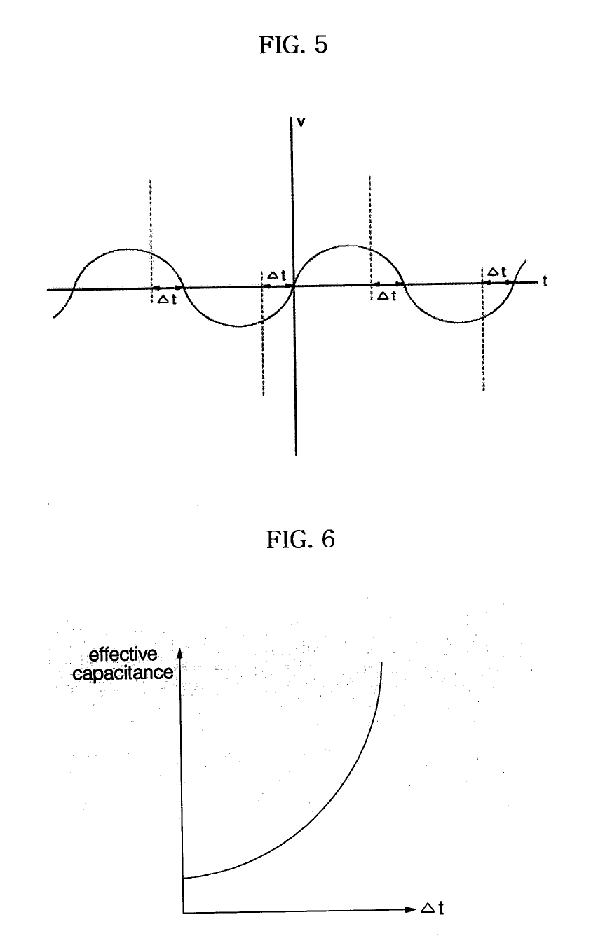

The single-phase induction motor controls the ON duration of the switch 10 to change the amount of current flowing through the motor, which is described below in detail with reference to FIGS. 5 and 6.

FIG. 5 is a graph illustrating how the switch 10 operates in phase with the frequency of AC voltage, and FIG. 6 is a graph illustrating the effective capacitance of the capacitor according to the operating state of the switch 10.

When the switch 10 is turned on, the amount of current flowing through the motor is increased, so that the effective capacitance of the capacitor C is increased and thus the motor runs at high speed with high torque. As the ON duration of the switch 10 increases, the effective capacitance of the capacitor C increases. It is thus possible to control the rotating speed of the motor and the amount of torque applied to the motor by controlling the ON duration of the switch 10.

As shown in FIG. 5, the switch 10 is turned on during a predetermined time Δt in phase with the frequency of the AC voltage applied to the motor, so that it is possible to change the effective capacitance of the capacitor C by controlling the switch 10 to be turned on/off.

When the switch 10 is repeatedly turned on during the predetermined time Δt in phase with the frequency of the AC voltage, the amount of current flowing through the motor per period of the AC voltage increases as the ON duration Δt of the switch 10 increases. In other words, the effective capacitance of the capacitor C increases as the ON duration Δt, for which the switch 10 is turned on in phase with the frequency of the AC voltage, increases. On the contrary, the effective capacitance of the capacitor C decreases as the ON duration Δt of the switch 10 decreases.

The graph of FIG. 6 illustrates the change of the effective capacitance of the capacitor C according to the ON duration Δt of the switch 10. It can be seen from this graph that the effective capacitance of the capacitor C increases as the ON duration Δt increases.

As the single-phase induction motor including the single capacitor C and the single switch 10 operates in the above manner, it can control the amount of torque applied to the motor and the rotating speed of the motor through the inexpensive switch 10, instead of using a plurality of capacitors. In addition, the single-phase induction motor according to the present invention can increase the effective capacitance of the capacitor C, compared to the conventional motor using a single capacitor C, so that it can run with high torque using a low-capacitance capacitor.

In one embodiment, the single-phase induction motor, which operates as described above, can be used as a motor of a washing machine. The washing machine with the single-phase induction motor according to the present invention operates in the following manner.

The washing machine performs wash and dry cycles by rotating the motor at low speed during the wash cycle and at high speed during the dry cycle (i.e., spin cycle).

In order to efficiently perform the wash and dry cycles, the washing machine may perform each of the wash and dry cycles in multiple steps, such that washing is performed at high speed for a predetermined time in the low-speed wash cycle, and drying is performed at low speed for a predetermined time in the high-speed drying cycle. A single-phase induction motor, which includes a capacitor and a switch connected thereto according to the present invention, can be used in the washing machine in order to perform each of the wash and dry cycles in multiple steps.

When the single-phase induction motor according to the present invention is applied to the washing machine, the speed of the motor can be changed by controlling the ON duration of the switch 10 in the wash and dry cycles, i.e., by turning on the switch 10 for a predetermined time in phase with the frequency of AC voltage applied to the washing machine as described above.

For example, in order to perform washing at high speed when the washing machine runs in the wash cycle, the ON duration of the switch 10 is increased to increase the amount of current flowing through the motor per period of the AC voltage applied to the motor, so that the motor runs at high speed with high torque.

In addition, in order to perform washing at low speed, the ON duration of the switch 10 is reduced so that the motor runs at low speed with low torque.

The washing machine can operate in the dry cycle in the same manner as described above. That is, the ON duration of the switch 10 is increased to perform high-speed drying, whereas it is reduced to perform low-speed drying.

In another embodiment, the single-phase induction motor, which is configured as described above, can be applied to a dishwasher.

In the same manner as the washing machine in the previous embodiment, the dishwasher, which employs the single-phase induction motor according to the present invention, controls the ON duration of the switch 10 to change the amount of current flowing through the motor according to the operating mode, thereby allowing the dishwasher to perform high-speed washing and low-speed washing alternately.

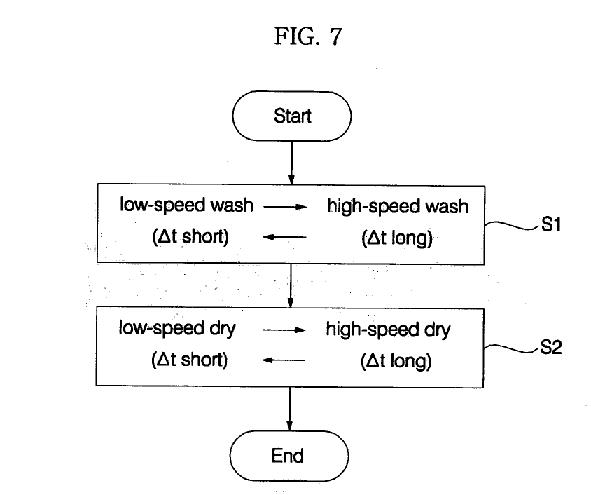

FIG. 7 is a flow chart of a method for controlling a single-phase induction motor used for a washing machine, where the motor includes a switch for controlling current flow in the motor to change the amount of current flowing through the motor. In the method, the ON duration of the switch is decreased to rotate the motor at low speed when the washing machine operates in the wash cycle (S1), and the ON duration of the switch is increased to rotate the motor at high speed when the washing machine operates in the dry cycle (S2).

In order to efficiently perform the wash and dry cycles, the washing machine performs each of the wash and dry cycles in multiple steps with different rotating speeds. To accomplish this, the ON duration of the switch is also increased to rotate the motor at high speed when the washing machine operates in the wash cycle. This allows the washing machine to operate in the wash cycle in multiple steps, alternating between low-speed washing and high-speed washing.

The ON duration of the switch is also decreased to rotate the motor at low speed when the washing machine operates in the dry cycle. This also allows the washing machine to operate in the dry cycle in multiple steps.

As apparent from the above description, the present invention provides a single-phase induction motor and a method for controlling the same, which reduces the number of capacitors used in the motor, thereby reducing manufacturing costs, and also attains a high effective capacitance using a low-capacitance capacitor.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A single-phase induction motor comprising a main winding, an auxiliary winding, and a capacitor, the motor further comprising:
a switch for controlling current flow in the motor to change the amount of current flowing through the motor, thereby changing an effective capacitance of the capacitor.

2. The motor according to claim 1, wherein the switch is connected in parallel with the capacitor.

3. The motor according to claim 2, wherein the switch is a triac.

4. The motor according to claim 2, wherein the motor controls ON duration of the switch to change the amount of current flowing through the motor.

5. The motor according to claim 4, wherein the switch is turned on for a predetermined time in phase with frequency of voltage applied to the motor.

6. The motor according to claim 5, wherein the motor increases the ON duration of the switch when rotating at high speed, and decreases the ON duration thereof when rotating at low speed.

7. The motor according to claim 1, wherein the motor is used for a washing machine.

8. The motor according to claim 7, wherein the motor increases ON duration of the switch when the washing machine operates in a high-speed wash cycle, and decreases the ON duration thereof when the washing machine operates in a low-speed wash cycle.

9. The motor according to claim 7, wherein the motor increases ON duration of the switch when the washing machine operates in a high-speed dry cycle, and decreases the ON duration thereof when the washing machine operates in a low-speed dry cycle.

10. The motor according to claim 1, wherein the motor is used for a dishwasher.

11. The motor according to claim 10, wherein the motor increases ON duration of the switch when the dishwasher operates in a high-speed wash cycle, and decreases the ON duration thereof when the dishwasher operates in a low-speed wash cycle.

12. A method for controlling a single-phase induction motor used for a washing machine, the motor including a switch for controlling current flow in the motor to change the amount of current flowing through the motor, the method comprising:
decreasing ON duration of the switch to rotate the motor at low speed when the washing machine operates in a wash cycle; and
increasing the ON duration of the switch to rotate the motor at high speed when the washing machine operates in a dry cycle.

13. The method according to claim 12, further comprising:
increasing the ON duration of the switch to rotate the motor at high speed when the washing machine operates in the wash cycle, so that the washing machine performs the wash cycle in multiple steps with different rotating speeds of the motor.

14. The method according to claim 12, further comprising:
decreasing the ON duration of the switch to rotate the motor at low speed when the washing machine operates in the dry cycle, so that the washing machine performs the dry cycle in multiple steps with different rotating speeds of the motor.
